(19) United States
(12) Patent Application Publication
(10) Pub. No.: US 2015/0006621 A1
(43) Pub. Date: Jan. 1, 2015

(54) Adaptive Video Streaming for Information Centric Networks

(71) Applicant: Futurewei Technologies, Inc., Plano, TX (US)

(72) Inventor: Cedric Westphal, San Francisco, CA (US)

(21) Appl. No.: 14/321,322

(22) Filed: Jul. 1, 2014

Related U.S. Application Data
(60) Provisional application No. 61/841,660, filed on Jul. 1, 2013.

(51) Int. Cl. H04L 29/06; H04L 29/08

(52) U.S. Cl. CPC H04L 65/602; H04L 67/42; H04L 67/02
USPC 709/203

(57) ABSTRACT

A method of adaptive video streaming implemented in a caching element operating in an information-centric network. The method comprises receiving a request for a media presentation description (MPD) for video content, obtaining the requested MPD, inserting a description of video content stored in the caching element into the MPD, and transmitting the MPD to a client requesting the MPD.

### CROSS-REFERENCE TO RELATED APPLICATIONS

The present application claims priority to U.S. Provisional Patent Application No. 61/841,660 filed Jul. 1, 2013 by Cedric Westphal and entitled “Adaptive Video Streaming for Information Centric Networks,” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

A network may include a plurality of memory locations in which data may be stored. Data stored in the network may exist in a plurality of different versions having different types of encoding and other variations in its configuration and characteristics. A memory location may hold multiple versions of the same data, and versions of the same data may be stored in multiple memory locations. When the network receives a request for the data, uncertainty may exist regarding the memory location from which the data may be retrieved and/or the version of the data which may be retrieved.

### SUMMARY

In one embodiment, the disclosure includes a method of adaptive video streaming implemented in a caching element operating in an information-centric network. The method comprises receiving a request for a media presentation description (MPD) for video content, obtaining the requested MPD, inserting a description of video content stored in the caching element into the MPD, and transmitting the MPD to a client requesting the MPD.

In another embodiment, the disclosure includes a method of adaptive video streaming implemented in a caching element operating in an information-centric network. The method comprises receiving a request for an MPD for video content. The method further comprises, when a memory of the caching element does not comprise the MPD, inserting a description of video content stored in the caching element into the MPD request and transmitting the MPD request to a server.

In another embodiment, the disclosure includes a caching element in an information-centric network. The caching element comprises a memory, a receiver, a processor, and a transmitter. The memory is configured to store a version of video content configured for the highest transmission rate compared to other versions of the video content received by the caching element. The receiver is configured to receive a request for a version of the video content with less than the highest transmission rate. The processor is configured to transcode the highest transmission rate version of the video content to a version with the requested transmission rate. The transmitter is configured to transmit the version with the requested transmission rate to a requesting entity.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an adaptive streaming video content delivery system according to an embodiment of the disclosure.

FIG. 2 is a schematic diagram of an adaptive streaming video content delivery system that includes a caching element according to another embodiment of the disclosure.

FIG. 3 is a protocol diagram of a method of modification of an MPD based on information in a cache according to an embodiment of the disclosure.

FIG. 4 is a protocol diagram of a method of modification of an MPD based on information in a cache according to another embodiment of the disclosure.

FIG. 5 is a protocol diagram of a method of modification of an MPD based on information in a cache according to another embodiment of the disclosure.

FIG. 6 is a schematic diagram of a network element according to an embodiment of the disclosure.

FIG. 7 is a flowchart illustrating a method for modifying an MPD and processing a request for video content according to an embodiment of the disclosure.

### DETAILED DESCRIPTION

It should be understood at the outset that, although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Information-centric networks (ICNs) have been proposed to meet the increasing demand for internet bandwidth. In an ICN, data storage capabilities may be added to routers or similar network elements, and the routers may thus become both forwarding elements and caching elements. Content may be transmitted to a client from either a server or an intermediate caching component on a path from the server to the client, depending on network conditions, and/or other factors. A router or other network element with such caching capabilities in an ICN may be referred to herein as a caching element or a cache. In an ICN, when a client makes a request for content, the client need not know the location of the content. Instead, content may be requested and routed by name rather than by location. That is, the client may specify the name of the desired content, and the ICN may determine whether the content is transmitted to the client by a server or by a caching element.

Another mechanism that has been proposed to meet increasing demands for internet bandwidth is the use of adaptive streaming, wherein data to be streamed over the internet exists in a plurality of different versions, which may be referred to as representations. Each version may be compressed to a different size and transmitted at a different rate. The version streamed to a given client at a given time may be adaptively selected based on network conditions at that time, the client's capabilities, and/or other factors.

Disclosed herein are mechanisms whereby adaptive streaming may be implemented in an ICN. Such mechanisms may be desirable since the concepts of adaptive streaming and information-centric networking may not be compatible and may at times operate in opposition to one another. In some embodiments, responsive to receiving a request for a manifest document describing requested video content, a cache may modify the manifest request or the manifest itself to indicate the cache holds video content referred to in the manifest request. In one such embodiment, if the cache holds video content referred to in the manifest but does not hold a copy of the manifest, the cache may insert a description of the video content into the manifest request. The cache may then forward the modified manifest request to a server that holds the requested manifest. The server may then update the requested manifest with the description of the video content in the cache and the uniform resource locator (URL) of the cache. The server may then return the modified manifest to a client that requested the manifest. In another embodiment, if the cache does hold a copy of the requested manifest, the cache may modify the manifest by inserting into the manifest a description of the relevant video content stored at the cache. The cache may then return the modified manifest to the client. In another embodiment, if the cache does not hold a copy of the requested manifest, instead of inserting a description of the relevant video content into the manifest request that is sent to the server, the cache may insert a description of the relevant video content into a manifest returned to the cache from the server on the way back to the client. The cache may then forward the modified manifest to the client.

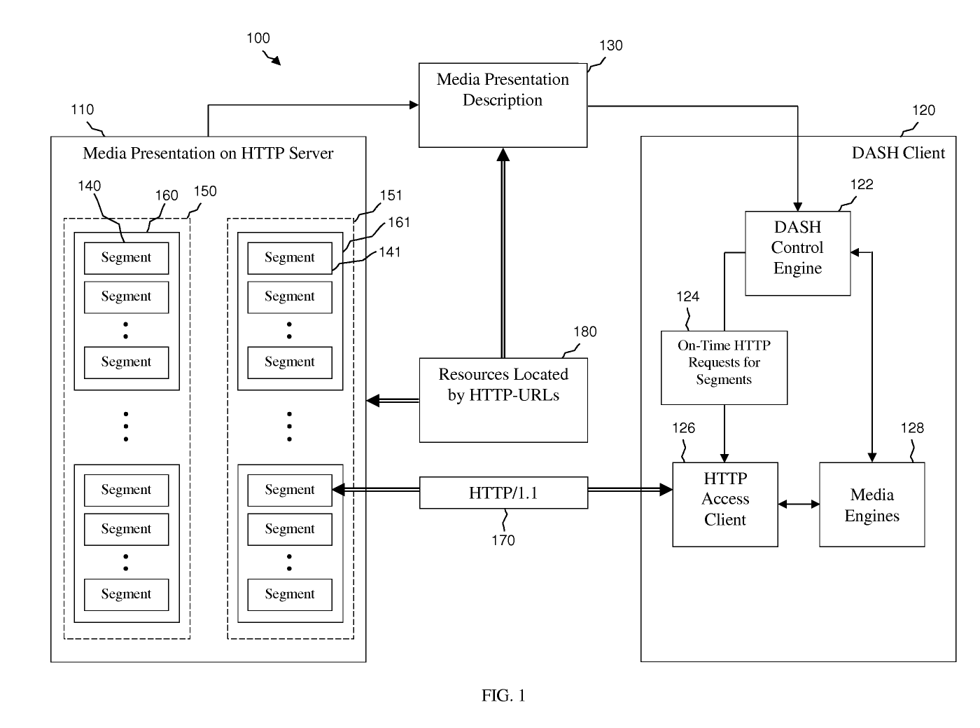

FIG. 1 is a schematic diagram of an embodiment of an adaptive streaming video content delivery system 100. Multiple different technologies and protocols are available for video streaming, and there may be multiple types of adaptive video formats. The discussion hereinafter will focus on a content delivery platform known as DASH (Dynamic Adaptive Streaming over Hypertext Transfer Protocol (HTTP)), but it should be understood that similar considerations may apply to other video content delivery platforms. The system 100 may include an HTTP server 110, a content provider server, or a similar component, which may hold a DASH media presentation. The media presentation may include multiple versions of a piece of video content, such as a movie, a television program, or a recorded sporting event. A DASH client 120 may receive video content transmitted from the server 110.

The different versions of video content on the server 110 may each comprise a plurality of data segments 140. The segments 140 may be configured such that each version of the content may be transmitted to the DASH client 120 at a different transmission rate. The DASH client 120 may begin downloading segments 140 of video content from the server 110 and use the speed at which the segments 140 are downloaded to estimate the data transmission rate which can be supported over the network connection between the DASH client 120 and the server 110. The DASH client 120 may begin downloading segments 140 of a smaller data size/resolution (e.g. to fill a buffer), and then may increasingly download segments 140 of a larger data size/resolution until either segments associated with a representation with the highest available size/resolution are obtained or until a segment of a higher size/resolution cannot be delivered in time to prevent buffer underruns due to network congestion. If network conditions subsequently deteriorate and the DASH client 120 is unable to process segments 140 at the current download rate without pausing video playback, smaller sized segments 140 may be downloaded until the DASH client 120 is again able to properly display the video content.

A video stream using DASH may start with the exchange of a manifest called a Media Presentation Description (MPD) 130 between the server 110 and the DASH client 120. The MPD 130 describes a decomposition of the video streams into segments 140 that each correspond to a specific time frame in the video stream, a specific encoding, and/or a specific resolution, compression, data size, etc. as well as a list of URLs indicating location(s) of the segments. Thus, a video may be represented in a time dimension and a data size dimension. The DASH client 120 may measure the throughput achieved in downloading a segment 140 corresponding to a time window, and may then select a representation/segment of an appropriate data size and associated encoding for the next time window to attain a download rate (e.g. of downloaded segments over time) which is supportable under current network conditions. The DASH client 120 may thus be reactive to variations in the channel quality on the path between the DASH client 120 and the server 110.

A DASH media presentation preparation function may prepare the media presentation for viewing by the DASH client 120. For example, the DASH media presentation preparation function may receive data regarding media content from a content provider or a similar entity and may prepare the MPD 130 to describe the media content. The MPD 130 may list URLs for keys, initialization vectors, ciphers, segments, and/or message authentication codes. The MPD 130 may list such URLs as static addresses and/or as functions that may be used to determine associated URLs.

The MPD 130 may comprise information for one or more periods. Each period may comprise one or more adaptation sets 150. Each adaptation set 150 may comprise one or more representations 160. Each representation 160 may comprise one or more segments 140. A period may comprise timing data and may represent a content period during which a consistent set of encoded versions of the media content is available (e.g., a set of available bit rates, languages, captions, subtitles etc., that do not change). An adaptation set 150 may represent a set of interchangeable encoded versions of one or several media content components. For example, a first adaptation set 150 may comprise a main video component, a second adaptation 151 set may comprise a main audio component, and a third adaptation set (not shown) may comprise captions. An adaption set 150 may also comprise multiplexed content, such as combined video and audio. A representation 160 may describe a deliverable encoded version of one or more media content components, such as an International Organization for Standardization (ISO) Base Media File Format (ISO-BMFF) version or a Moving Picture Experts Group (MPEG) version two transport system (MPEG-2 TS) version. A representation 160 may describe, for example, any codecs, encryption, and/or other data for presenting the media content.

The DASH client 120 may dynamically switch between representations 160 and 161 (e.g. when representations 160 and 161 are part of a common adaptation set) based on network conditions, device capability, user choice, and/or other factors, which may result in obtaining associated segments 140 and/or 141. Such dynamic switching may be referred to as adaptive streaming. Each segment 140 may comprise media content data, may be associated with a URL, and may be retrieved by the DASH client 120, e.g., with an HTTP GET request. Each segment 140 may contain a pre-defined byte size (e.g., 1000 bytes) and/or an interval of playback time (e.g., two or five seconds) of the media content. A segment 140 may comprise the minimal individually addressable unit of data that can be downloaded using URLs advertised via the MPD 130. The periods, adaptation sets 150, representations 160, and/or segments 140 may be described in terms of attributes and elements, which may be modified to affect the presentation of the media content by the DASH client 120.

After preparing the MPD 130, the DASH media presentation preparation function may deliver the MPD 130 to an MPD delivery function. When the DASH client 120 requests delivery of the MPD 130, the MPD delivery function may respond with the MPD 130. Based on the address data in the MPD 130, the DASH client 120 may request appropriate segments 140 from a DASH segment delivery function. Segments 140 may be retrieved from a plurality of DASH segment delivery functions and/or from a plurality of URLs and/or physical locations. The DASH client 120 may present the retrieved segments 140 to a user based on the instructions in the MPD 130.

The DASH client 120 may include a DASH control engine 122, which may send on-time HTTP requests 124 for segments 140. The requests 124 may be sent via an HTTP access client 126, which may interact with the server 110 via HTTP/1.1 170, e.g. by employing HTTP GET commands over a network (e.g. the Internet). The DASH control engine 122 may also interact with one or more media engines 128 to select appropriate representations for presentation to a user. Resources on the server 110 may be located by the DASH client 120 using HTTP URLs in the MPD 130, as indicated at block 180.

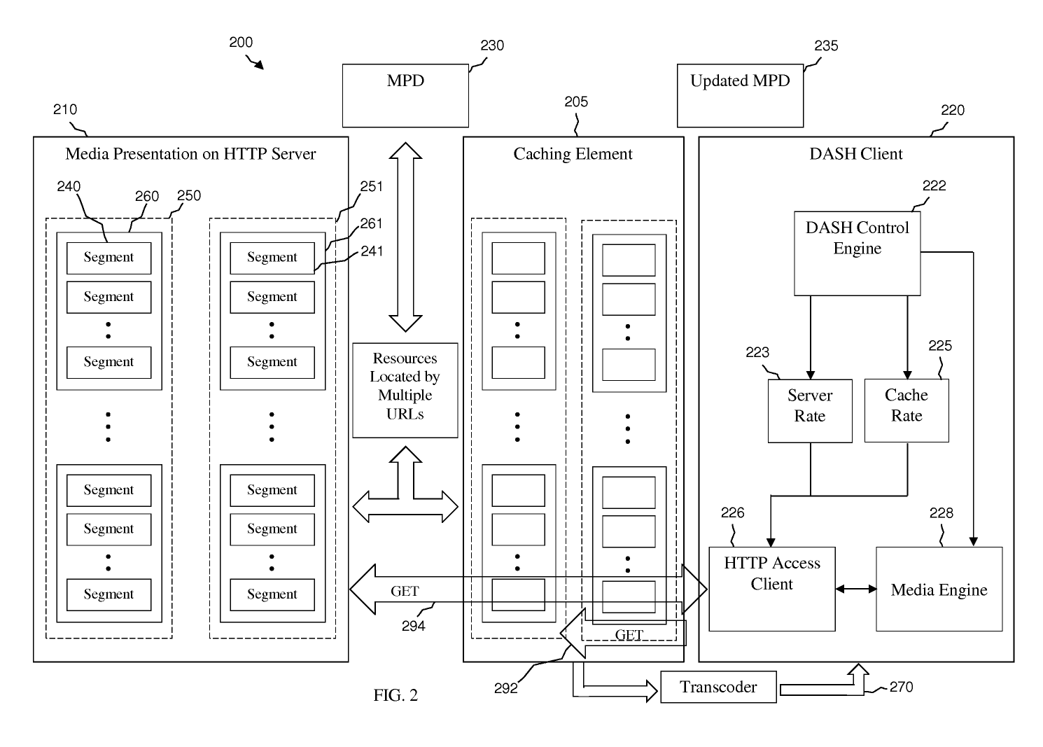

FIG. 2 illustrates an embodiment of an adaptive streaming video content delivery system 200, which includes a caching element 205 that may be a component in an ICN. The DASH content delivery system 200 may also include a server 210 and an MPD 230 that may be substantially similar to the server 110 and the MPD 130 of FIG. 1, respectively. The server 210 may include one or more media presentations comprising segments 240 and 241, representations 260 and 261, and adaptation sets 250 and 251, which may be substantially similar to the segments 140 and 141, representations 160 and 161, and adaptation sets 150 and 151, respectively, of FIG. 1. The DASH content delivery system 200 may also include a DASH client 220 that may be configured to interact with an ICN that includes the cache 205 and be configured to employ adaptive streaming. The DASH client 220 may comprise a DASH Control Engine 222, a Media Engine 228, and an HTTP Access Client 226, which may be substantially similar to the DASH Control Engine 122, Media Engine 128, and HTTP Access Client 126 of FIG. 1, respectively.

The cache 205 may reside in a content network and may be configured to store popular data content (e.g. video content). For example, a plurality of cache elements 205 may be positioned in geographically distant locations. Such cache elements 205 may be located much closer to the DASH clients 205 than the server 210, which may support faster download times for the DASH clients 205. Caches 205 may comprise limited storage space, but may support a large number of servers 210, each with a large amount of content. As such, the caches 205 may only comprise commonly requested (popular) content. Requests for less commonly requested content may be forwarded directly to the associated server 210.

Several complications may arise when a caching element 205 is implemented in the DASH content delivery system 200. For example, when video content is cached in a case where adaptive streaming is not used, only one version of each piece of content may be available for cache 205 storage. However, when content caching is used in conjunction with adaptive streaming, multiple versions of each piece of content may be available for storage. Saving a large number of representations of a single piece of content may burden the cache. Additionally, requests for different versions/representations of a single piece of content may be viewed by the ICN as requests for separate pieces of content, which may result in an improperly low popularity ranking for the content and a reduced likelihood the content will remain cached in the caching element 205. Further, storing some versions/representation of a piece of content at a cache 205 but not other versions may lead a caching element 205 to return a cache miss in response to a request even though another version of the content is available at the cache 205.

Furthermore, if the MPD 230 was generated to describe content stored on the server 210, the MPD 230 may not include a description of content stored in the cache 205, and the DASH client 220 may thus be unaware of content in the cache 205. Additionally, ICN may be designed to be location agnostic. Accordingly, a client 220 may not be natively aware of which entity (e.g. the server 210 or the cache 205) is providing content at a given time. Such lack of awareness may result in swings in round-trip time between segments depending on serving location. Accordingly, DASH calculations based on round-trip time may lead to undesirable client 220 behavior. For example, if segments with a smaller file size exist on the cache 205 and segments of a larger file size exist on the server 210, the client 220 may quickly fill up its buffer from the cache 205, prompting the client 220 to seek a slightly larger file size from the server 210. Due to potentially drastic differences in network conditions between the server 210 and the client 220 and the cache 205 and the client 220, the client 220 may be unable to receive the slightly larger file size from the server 210 in a timely manner, prompting the client 220 to request the smaller file size at the cache 205. Such a scenario, may result in the client 220 continually thrashing between server 210 and cache 205.

The forgoing issues may be addressed by system 200. In a first embodiment, DASH client's 220 DASH control engine 222 may maintain awareness of a server rate 223 and a cache rate 225. Specifically, the server rate 223 may measure and/or maintain the rate of data transfer from the server 210 and the cache rate 225 may measure and/or maintain the rate of data transfer from the cache 205. By considering a round trip time for the server and a round trip time for a cache separately, the DASH control engine 222 may consider the download location when determining which representation to employ to prevent thrashing. The video content may be stored with an indicator that indicates the storage location of the video content. By examining the indication, the client 220 may determine whether the cache 205 or the server 210 is the source of a particular segment of the video content at any given time.

In another embodiment, the system 200 may employ an updated MPD 235. For example, MPD 230 may be a single file created when content is first received by the publisher. The MPD 230 may be dynamically modified to create the updated MPD 235 based on the dynamically changing location of the associated content in the content network. The updated MPD 235 may be stored on the cache 205 or on the server 210. In either case, the updated MPD 235 may be dynamically updated to indicate the location(s) of particular segments (e.g. at a plurality of caches 205) as discussed more fully below.

In yet another embodiment, the cache element 205 may comprise a transcoder 270. The cache 205 may be configured to store a single copy of the highest quality version of a particular piece of content (e.g. segment) that is available to the cache 205. Quality may be a reference to the file size of the segment, such that a large file size may result in a more accurate representation of the original content, while a compressed file may result in a less accurate representation (e.g. pixilated video, poor quality sound, etc.) with a smaller file size which can be more easily downloaded. Upon request for a particular representation, the cache element 205 may employ the transcoder 270 to transcode the stored segment(s) into the representation requested by the DASH client 220. Depending on the embodiment, the cache 205 may passively retain the highest quality representation of a particular segment that passes through the cache 205 on the way to the client 220 or the cache 205 may obtain/receive and store only the highest quality/highest file size representation of a particular segment available in the content network.

In yet another embodiment, the client 220 may communicate with the cache 205 and the server 210 with GET 294 and/or 292 messages/functions. GET 292 may allow the client 220 to obtain a segment from the cache 205 and GET 294 may allow the client 220 to obtain a segment from the server 210, respectively. GET 294 may or may not be routed via the cache 205 (e.g. address to the cache 205 and forwarded by the cache 205) in either or both the upstream and downstream directions. The GET 294 and/or 292 may be configured to allow a client 220 to request a representation by a range instead of requesting a specific representation. For example, the client may format a GET request with parameters GET (movie file f, segment time t, bandwidth <b), where movie file f indicates the name of a movie file, segment time t indicates a specified time in the movie file, and bandwidth <b indicates the bandwidth required to support the transfer of the segment should be less than a requested value b. The cache may then respond by transferring the highest file size version of the indicated segment associated with a bandwidth requirement of less than b. If no such file meets the criteria, the GET request may be forwarded to the server 210.

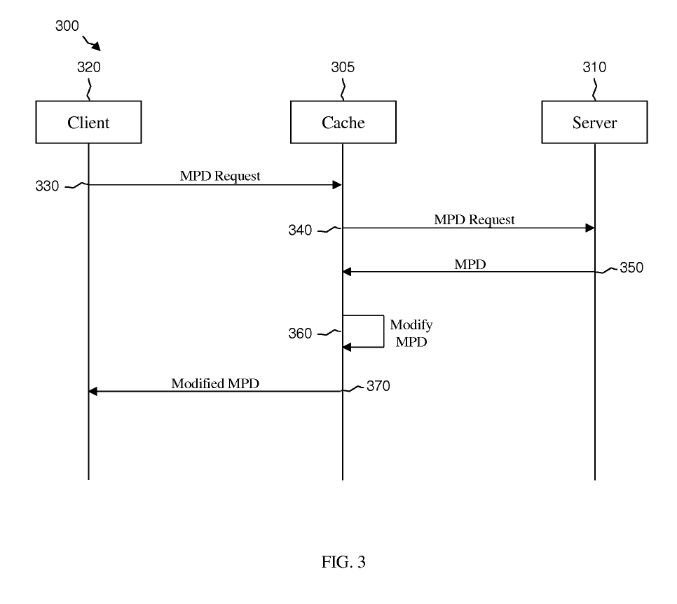

FIG. 3 is a protocol diagram of a method 300 of modification of an MPD based on information in a cache according to an embodiment of the disclosure. A client 320, a cache 305, and a server 310 may be substantially similar to the client 220, the cache 205, and the server 210 of FIG. 2. Cache 305 may not store an MPD associated with a particular content, for example because the cache 305 is not configured to store MPDs, because the cache 305 has not stored any data related to the content, and/or because the cache 305 comprises some segment data related to the content but not an associated MPD. At step 330, the client 320 may send an MPD request to the cache 305. At step 340, the cache 305 may forward the MPD request to the server 310. The cache 305 may also insert any relevant authentication data into the MPD request or may rely on authentication data encoded in the MPD request by the client, depending on the embodiment. At step 350, the server 310 may return the requested MPD to the cache 305. At step 360, the cache 305 may modify the MPD received from the server 310 to include the description of any video content stored at the cache 305 associated with the MPD request of step 330. Such content may have been previously available at the cache 305 and/or may have been received prior to receiving the MPD of step 350, for example via other ICN related processes. At step 370, the cache 305 may forward the modified MPD to the client 320.

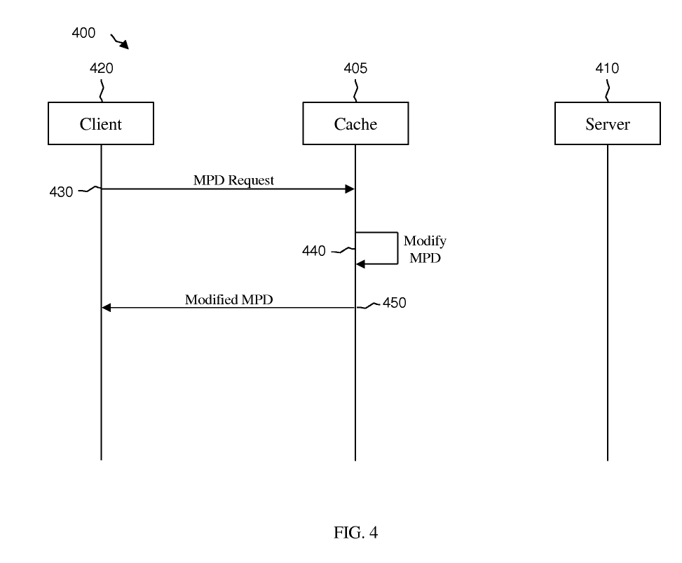

FIG. 4 is a protocol diagram of a method 400 of modification of an MPD based on information in a cache according to another embodiment of the disclosure. A client 420, a cache 405, and a server 410 may be substantially similar to the client 220, the cache 205, and the server 210 of FIG. 2. At step 430, the client 420 may send an MPD request to the cache 405. At step 440, the cache 405 may determine the requested MPD is stored on the cache 405 and may modify the MPD to include an updated description of video content stored at the cache 405. At step 450, the cache 405 may send the modified MPD to the client 420.

In either of the above two embodiments, a cache may receive an MPD request, obtain the requested MPD, insert into the MPD a description of video content held in the cache, and transmit the modified MPD to a client that requested the MPD. In the former of the above two embodiments, the cache may receive the requested MPD from a server. In the latter of the above two embodiments, the cache may retrieve the requested MPD from an internal memory location. In some embodiments, the cache may also insert into the MPD a description of any representations of the video content that the cache is able to transmit. For example, a cache with the ability to transcode may modify the MPD to reflect a range of representations that the cache is capable of producing by transcoding video content stored at the cache.

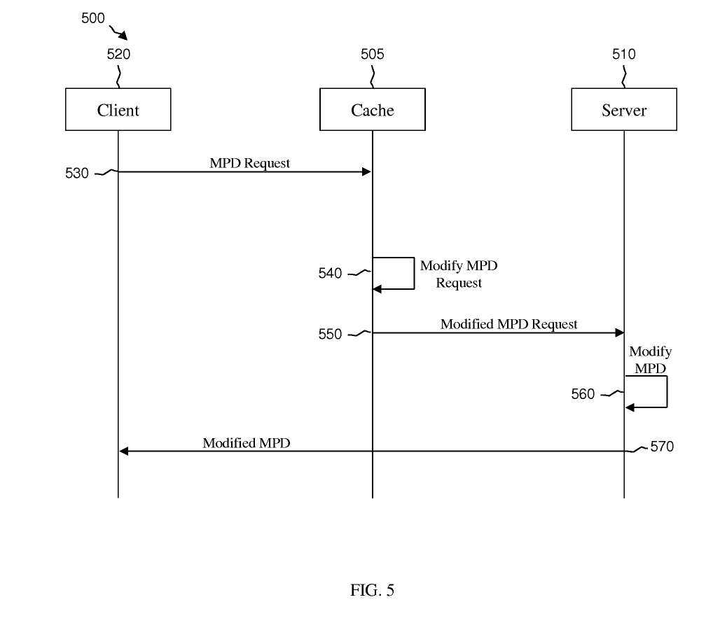

FIG. 5 is a protocol diagram of a method 500 of modification of an MPD based on information in a cache according to another embodiment of the disclosure. A client 520, a cache 505, and a server 510 may be substantially similar to the client 220, the cache 205, and the server 210 of FIG. 2. Cache 505 may not comprise a copy of an MPD file requested by client 520 (e.g. because the cache 505 may not be configured to store MPD files). At step 530, the client 520 may send an MPD request to the cache 505. At step 540, the cache 505 may modify the MPD request to include a current description of video content stored at the cache 505. At step 550, the cache 505 may forward the modified MPD request to the server 510. At step 560, the server 510 may modify an MPD stored at the server 510 based on the information in the modified MPD request of step 550. At step 570, the server 510 may send the modified MPD to the client 520. By maintaining a centralized MPD file, the server 510 may maintain awareness of the location of the segments throughout the content network.

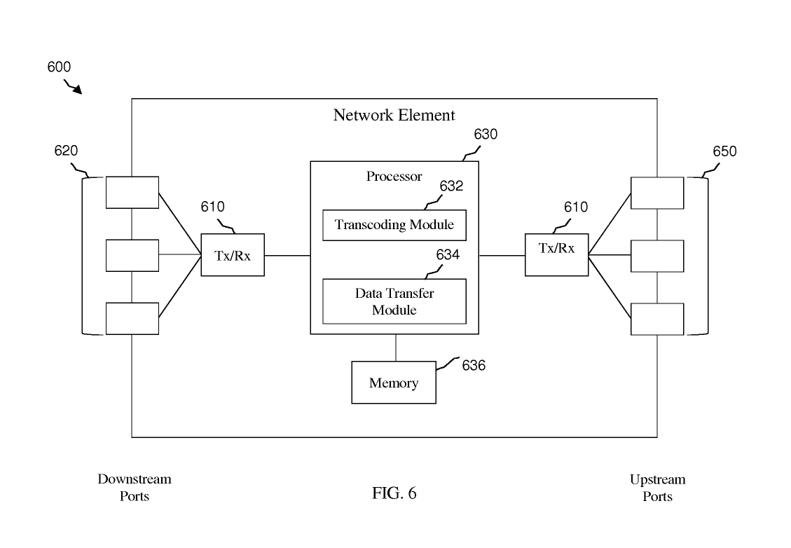

FIG. 6 is a schematic diagram of an embodiment of a network element (NE) 600 which may be suitable for implementing one or more embodiments of the systems, methods, and schemes disclosed herein. For example, the NE 600 may act as the server 210, cache 205, and/or the DASH client 220 of FIG. 2. The NE 600 may be implemented in a single node, or the functionality of the NE 600 may be implemented in a plurality of nodes. One skilled in the art will recognize that the term NE encompasses a broad range of devices of which NE 600 is merely an example. NE 600 is included for purposes of clarity of discussion, but is in no way meant to limit the application of the present disclosure to a particular NE embodiment or class of NE embodiments. At least some of the features and methods described in the disclosure may be implemented in a network apparatus or component such as an NE 600. For instance, the features/methods in the disclosure may be implemented using hardware, firmware, and/or software installed to run on hardware.

As shown in FIG. 6, the NE 600 may comprise transceivers (Tx/Rx) 610, which may be transmitters, receivers, or combinations thereof. A Tx/Rx 610 may be coupled to a plurality of downstream ports 620 for transmitting and/or receiving data from downstream entities. A Tx/Rx 610 may also be coupled to a plurality of upstream ports 650 for transmitting and/or receiving data from upstream entities. A processor 630 may be coupled to the Tx/Rxs 610 to process the data and/or determine which nodes to send data to. Depending on the embodiment, the processor 630 may include a transcoding module 632 for performing the transcoding functions described herein. The processor 630 may also include a data transfer module 634 for transferring data (e.g. transfer and/or storage of MPD, representation, and/or segment data) as discussed herein. In an alternate embodiment the modules 632 and/or 634 may be partially or completely implemented in memory 636. The processor 630 may comprise one or more multi-core processors and/or memory devices 636, which may function as data stores, buffers, etc. Processor 630 may be implemented as a general processor or may be part of one or more application specific integrated circuits (ASICs) and/or digital signal processors (DSPs). The downstream ports 620 and/or upstream ports 650 may contain electrical and/or optical transmitting and/or receiving components.

It is understood that by programming and/or loading executable instructions onto the NE 600, at least one of the processor 630, the data transfer module 632, the MPD module 634, Tx/Rxs 610, memory 636, downstream ports 620, and/or upstream ports 650 are changed, transforming the NE 600 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is subject to frequent change may be preferred to be implemented in software, because re-spinning a hardware implementation is more expensive than re-spinning a software design. Generally, a design that is stable that will be produced in large volume may be preferred to be implemented in hardware, for example in an ASIC, because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

It should be understood that any processing of the present disclosure may be implemented by causing a processor (e.g., a general purpose central processing unit (CPU) inside a computer system) in a computer system to execute a computer program. In this case, a computer program product can be provided to a computer or a mobile device using any type of non-transitory computer readable media. The computer program product may be stored in a non-transitory computer readable medium in the computer or the network device. Non-transitory computer readable media may include any type of tangible storage media. Examples of non-transitory computer readable media include magnetic storage media (such as floppy disks, magnetic tapes, hard disk drives, etc.), optical magnetic storage media (such as magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM, flash ROM, and random access memory (RAM)). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g., electric wires or optical fibers) or a wireless communication line.

In any of the embodiments discussed herein, upon receiving an updated MPD describing the locations of video content at the cache and video content at the server, the DASH client may fetch video content from the most appropriate location. The DASH client may have a choice of using all segments available in the updated MPD from the server or a subset of the segments. The DASH client may calculate a desired download rate based on the throughput to be achieved, which may differ depending on whether the video content is fetched from the cache or from the server. This difference may cause an undesirable oscillation between fetching video content from the server and fetching video content from the cache.

That is, in video streaming mechanisms, a client may measure the round trip time between issuing a request and receiving a response. That time may be used to estimate the transmission rate the client requests and to determine how the client adapts the transmission rate. If the round trip time is relatively fast, the client may increase the transmission rate to a higher rate. If the round trip time is relatively slow, the client may decrease the rate to a lower rate. In a situation where both adaptive streaming and caching are implemented, the round trip time between a client and a cache may be faster than the round trip time between the client and a server. If the client receives video content from the cache that is configured for a relatively slow transmission rate, the client may receive the content with a relatively short round trip time. Based on that round trip time, the client may assume that a faster transmission rate may be supported for the video content and may then request additional video content configured for a relatively fast transmission rate. If video content configured for the faster transmission rate is not available at the cache, the requested video content may be retrieved from the server. When the client measures the round trip time of the transmission from the server, the client may measure a round trip time greater than the round trip time previously measured for the transmission from the cache. The client may then assume that a slower transmission rate is needed and may request additional video content configured for a relatively slow transmission rate. The video content with the slower rate may again be provided by the cache, and another cycle of alternating between transmissions from the cache and transmissions from the server may begin. Such oscillations between a higher transmission rate and a lower transmission rate may be detrimental to the experience of the user and may lead to poor performance in the delivery time of content as well.

In an embodiment, information may be provided to a client in an ICN informing the client whether video content transmitted to the client was transmitted from a server or from a cache. The distinction between video content coming from a server and video content coming from a cache may be achieved by giving different names to video content coming from different sources. Alternatively, such a distinction may be achieved by associating a flag or some other type of indicator with the video content to indicate whether the source of the video content is a server or a cache. Alternatively, such a distinction may be achieved by providing a location hint regarding the source of the video content. A location hint that may be implemented for such a purpose is described in U.S. patent application Ser. No. 14/147,346, filed Jan. 3, 2014 and entitled “An End-User Carried Location Hint for Content in Information-Centric Networks”, which is incorporated herein by reference.

Responsive to receiving the information indicating the source of a piece of video content, a client may take appropriate steps to prevent the oscillation described above. For example, if the client learns that the server cannot deliver data at the highest transmission rate, the client may not request data from the server at the highest transmission rate.

Additional embodiments are directed toward a cache's activities regarding which version or versions of video content to retain for future transmissions to a client and regarding which version of video content is transmitted to a client responsive to a request from the client. Multiple different versions of the same video content may pass through a cache at different times, and the cache may not have sufficient storage capacity to retain every version of every piece of content that has passed through. Therefore, it may be desirable for the cache to have a capability to determine which video content to retain and which to delete.

During the course of the operation of a cache, the cache may receive a plurality of versions of a piece of video content, each configured for transmission at a different rate. The cache may receive the versions by actively requesting the versions from a server or by retaining the versions as the versions pass through the cache from a server in response to a request from a client.

In an embodiment, a caching element may have the capability to transcode video content from a version configured for transmission at a relatively higher rate to a version configured for transmission at a relatively lower rate. In an embodiment, such a cache may be configured to retain the version of a given piece of video content that is configured for the highest transmission rate compared to all the versions of that content that have passed through the cache. The cache may delete all other versions of that content. In an embodiment, if the cache receives a request for a version of that video content configured for a transmission rate lower than that of the retained version, the cache may transcode the higher transmission rate version to the requested lower transmission rate version and return the lower transmission rate version to the requesting client.

In another embodiment, when a cache receives a request for a version of video content configured for a transmission rate that is not available at the cache, the cache may return a version of the video content with a transmission rate that is available at the cache. Allowing the cache to respond with content configured for an available transmission rate rather than a requested transmission rate may improve the hit rate performance in an ICN with adaptive streaming.

In another embodiment, a client is provided with a capability to specify a desired piece of video content by one or more parameters associated with the content in addition to the name of the content. For example, a desired piece of content may be specified by the name of the content and a specified period of time within the content. Alternatively, a desired piece of content may be specified by bandwidth or bandwidth range. For instance, a client may request that a cache return a piece of content that has a bandwidth between a lower limit and an upper limit. Alternatively, a client may request that a cache return a piece of content associated with a bandwidth less than a specified level. Providing a client with the capability to specify a desired bandwidth or bandwidth range for a desired piece of content may alleviate the issues discussed above regarding oscillation between two transmission rates and regarding the cache determining which version of video content to return to a client.

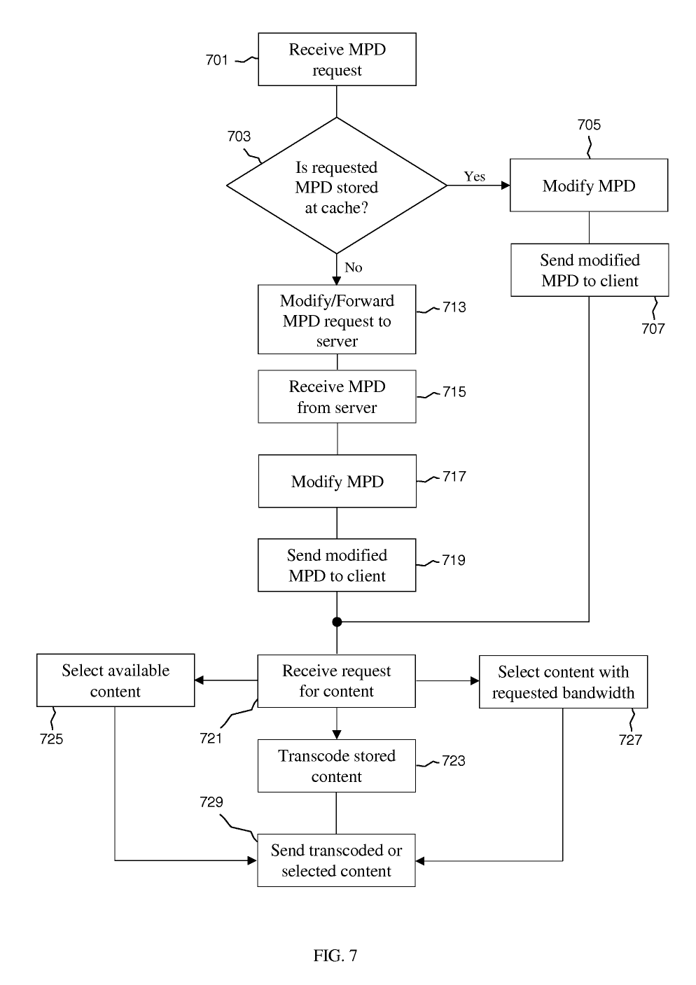

FIG. 7 is a flowchart illustrating a method 700 for modifying an MPD and processing a request for video content according to an embodiment of the disclosure, which may be implemented on a cache such as cache 205. At block 701, a cache may receive a request for an MPD. At block 703, the cache may determine whether the requested MPD is stored at the cache. If the requested MPD is stored at the cache then, at block 705, the cache may modify the stored MPD with a description of the video content that is stored in the cache and that is associated with the requested MPD. At block 707, the cache may transmit the modified MPD to a requesting client.

If, at block 703, if it is determined the requested MPD is not stored at the cache, the method may proceed to block 713. At block 713, the cache may forward the MPD request to a server. Depending on the embodiment, the cache may also modify the MPD request with a description of the video content stored in the cache and associated with the requested MPD. At block 715, the cache receives the requested MPD from the server. At block 717, the cache may modify the received MPD with a description of the video content stored in the cache and associated with the requested MPD (for example, when the MPD request is not modified at step 713). At block 719, the cache may transmit the modified MPD to a requesting client.

When the actions in any of the paths from block 703 are complete, the cache, at block 721, may receive a request for video content. Depending on the embodiment, the cache may respond in a variety of ways. If the video content request is for a version of the video content configured for a lower transmission rate/bandwidth than the version of the video content that is stored at the cache, the cache, at block 723, may transcode the stored version to a version that has the requested transmission rate/bandwidth. If the video content request is for a version of the video content configured for a transmission rate higher than the version of the video content that is stored at the cache, the cache, at block 725, may select the lower transmission rate. At block 727, if the request specifies a desired bandwidth or bandwidth range for the requested video content, the cache may select a stored version with the requested bandwidth or bandwidth range or may transcode a stored version to a version with the requested bandwidth or bandwidth range. At block 729, the cache may send a selected or transcoded version of the video content to a requesting client.

The embodiments disclosed herein may involve modifications in either Internet Protocol (IP) or ICN networks. In an IP network, a client may establish a session with a server and may not receive packets from multiple sources. A Transmission Control Protocol (TCP) session established between the client and a cache may appear to the client to be a session with the server, over which packets may be received indiscriminately. In an embodiment, a tag label may be added into a video stream to identify either the cache or the server (or multiple caches and servers) so that the client is able to update the proper channel estimation upon receiving a packet. The caching platform may also optimize its caching policy with respect to which rates are most likely to be requested so as to avoid caching all rates and wasting caching space on redundant information. For instance, the cache policy may be to cache only the rates likely to be supported by a typical client and not rates that are higher or lower. A cache at an aggregation point for a residential broadband connection, for instance, may cache only the rates those users may request. The client may then be able to choose, using a modified MPD, either an available rate or a different rate from the server. Such functionality may differ from previous versions of DASH, where the client may select the best rate that can be achieved. In the disclosed frameworks, the client may select the best rate which can be achieved from the server or any rate which is better from the cache. This rate from the cache may not be the best rate, since the best rate for the specific client/cache connection may not be available in the cache.

In an embodiment, to make channel prediction more accurate, a comparison may be made regarding the channel estimation between the client and the cache and the channel estimation between the client and the server. For example, if a bottleneck is present between the client and the cache, due to poor wireless conditions for instance, the channel estimation may be the same between the client and the cache and between the client and the server.

The embodiments disclosed herein provide a caching platform that is both DASH-aware and ICN-aware. The caching platform can advertise, to either a client or a server, the availability of segments from a video stream. The caching platform can also modify an MPD in a transparent manner or in an authenticated manner so as to support on-path caching. Furthermore, the caching platform can optimize its caching selection based on the history of rate requests seen from its population of clients and therefore focus its caching on the most productive encodings. The disclosed embodiments may be implemented in a transparent manner to the client and the server. The quality of experience of the end user may be improved as the embodiments offer the client a choice of a better connection between the client and the cache at the edge or a wider selection of segments between the client and the server. Peering traffic may be reduced for the network operator, which may be assumed to operate the cache as well. In particular, the client may be allowed to select rates from the cache that do not satisfy the criteria of DASH for the best possible rate, but the rates may still be an improvement over the best rate available from the server. Thus, the client receives a better rate than by receiving content from the server, while the operator is able to maintain traffic within its network.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means +/−10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and may be made without departing from the spirit and scope disclosed herein.

What is claimed is:

1. A method of adaptive video streaming implemented in a caching element operating in an information-centric network, the method comprising:
receiving a request for a media presentation description (MPD) for video content;
obtaining the requested MPD;
inserting a description of video content available at the caching element into the MPD; and
transmitting the MPD to a client requesting the MPD.

2. The method of claim 1, wherein, when a memory of the caching element does not comprise the MPD, the method further comprises:
forwarding the MPD request to a server responsive to receiving the MPD request; and
inserting the description of the video content into the MPD responsive to receiving the MPD from the server.

3. The method of claim 1, wherein, when a memory of the caching element comprises the MPD, the method further comprises:
obtaining the requested MPD from the memory of the caching element.

4. The method of claim 1, further comprising:
retaining a representation of the video content configured for a highest transmission requirement compared to other representations of the video content received by the caching element;
responsive to receiving a request for a representation of the video content with less than the highest transmission requirement, transcoding the highest transmission requirement representation of the video content to the requested representation; and
transmitting the requested representation to the client.

5. The method of claim 4, wherein inserting a description of the video content available at the caching element comprises inserting a description of a range of representations of the video content that the caching element is configured to produce via transcoding.

6. The method of claim 1, further comprising:
receiving from the client a request for a representation of the video content with a transmission requirement that is not available at the caching element; and
returning to the client a representation of the video content that is available at the caching element and comprises a transmission requirement that is lower than the requested transmission requirement.

7. The method of claim 1, further comprising:
receiving from the client a video content request that specifies a desired bandwidth range for the video content; and
transmitting to the client video content with a transmission requirement within the desired bandwidth range.

8. The method of claim 7, wherein a representation of the video content available at the caching element is transcoded to a representation of the video content with the desired bandwidth range.

9. The method of claim 1, wherein the video content stored in the caching element includes an indicator indicating to the client that the caching element is the source of the video content.

10. A method of adaptive video streaming implemented in a caching element operating in an information-centric network, the method comprising:
receiving a request for a media presentation description (MPD) for video content;
when a memory of the caching element does not comprise the MPD, inserting a description of video content available at the caching element into the MPD request; and
forwarding the MPD request to a server.

11. The method of claim 10, further comprising:
retaining a representation of the video content configured for a highest transmission requirement compared to other versions of the video content received by the caching element;
responsive to receiving a request for a representation of the video content with less than the highest transmission requirement, transcoding the highest transmission requirement representation of the video content to a representation with the requested transmission requirement; and
transmitting the representation with the requested transmission requirement to a client requesting the MPD.

12. The method of claim 10, further comprising:
receiving from a client a request for a representation of the video content with a transmission requirement that is not available at the caching element; and
returning to the client a representation of the video content with a transmission requirement that is available at the caching element.

13. The method of claim 10, further comprising:
receiving from a client a video content request that specifies a desired bandwidth range for the video content; and
transmitting to the client video content within the desired bandwidth range.

14. The method of claim 10, wherein the video content stored in the caching element includes an indicator indicating to a recipient of the video content that the caching element is the source of the video content.

15. A caching element configured to operate in an information-centric network, the caching element comprising:
a memory configured to store a representation of video content configured for a highest transmission requirement compared to other versions of the video content received by the caching element;
a receiver configured to receive a request for a representation of the video content with a lower transmission requirement than the transmission requirement of the stored representation;
a processor coupled to the memory and the receiver and configured to transcode the stored representation of the video content to the requested representation; and
a transmitter coupled to the processor and configured to transmit to the requesting entity the transcoded representation of the video content comprising the transmission requirement requested by the requesting entity.

16. The caching element of claim 15, wherein the receiver is further configured to receive a request for a media presentation description (MPD) for the video content, wherein the processor is further configured to insert into the MPD request a description of video content stored in the caching element, and wherein the transmitter is further configured to transmit the modified MPD request to a server.

17. The caching element of claim 16, wherein the receiver is further configured to receive the MPD from the server, wherein the processor is further configured to modify the MPD with a description of video content stored in the memory, and wherein the transmitter is further configured to transmit the modified MPD to the requesting entity.

18. The caching element of claim 15, wherein the receiver is further configured to receive a request for a media presentation description (MPD) for the video content, wherein the MPD is stored in the memory, wherein the processor is further configured to modify the MPD stored in the memory with a description of video content stored in the memory, and wherein the transmitter is further configured to transmit the modified MPD to the requesting entity.

19. The caching element of claim 15, wherein the receiver is further configured to receive a request for the video content that specifies a desired bandwidth range for the video content, and wherein the transmitter is further configured to transmit a representation of the video content within the desired bandwidth range to the requesting entity.

20. The caching element of claim 15, wherein the video content stored in the memory includes an indicator indicating to a recipient of the video content that the caching element is the source of the video content.
